(19) United States
(12) Patent Application Publication
(10) Pub. No.: US 2018/0357681 A1
(43) Pub. Date: Dec. 13, 2018

(54) DUAL-DISPLAY DIGITAL SIGNAGE APPARATUS FOR OUTDOOR USE

(71) Applicant: Lane Sullivan, Keene, NH (US)

(72) Inventor: Lane Sullivan, Keene, NH (US)

(21) Appl. No.: 15/621,722

(22) Filed: Jun. 13, 2017

(51) Int. Cl. G06Q 30/02; G06F 3/0482; G06F 1/16

(52) U.S. Cl. CPC G06Q 30/0277; H04W 76/02; G06F 1/1647; G06F 3/0482

(57) ABSTRACT

A digital signage apparatus suitable for outdoor use includes a pair of digital displays mounted within a weatherproof enclosure. The digital signage apparatus downloads promotional campaigns defined by a user from a centralized computer server. To facilitate electronic communications, the digital signage apparatus includes a wireless network communication module mounted in the enclosure. The digital signage apparatus includes a main control module that controls the content being displayed on the digital displays. The digital signage apparatus may further include a microphone, speaker, and digital camera that allow consumers to video conference with a listing agent over a cellular phone network. The digital signage apparatus may be remotely controlled by an assigned user through a website hosted by the centralized computer server.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

### 1. The Field of the Invention

The present invention relates to improvements in digital marketing and, more particularly, digital signage for outdoor applications.

### 2. Description of Related Art

Digital marketing has been used effectively for many years. It is used in many different markets, including digital signage. Currently, electronic technology does not adequately support mobile or smaller digital signage for outdoor use. The present invention addresses these shortcomings by providing a mobile and portable digital signage apparatus and method suitable for outdoor use.

### BRIEF DESCRIPTION OF THE DRAWINGS

The features and advantages of the disclosure will become apparent from a consideration of the subsequent detailed description presented in connection with the accompanying drawings in which:

FIG. 1 is a block diagram of a digital signage system according to an embodiment of the present disclosure;

FIG. 2A depicts a front, perspective view of digital signage according to an embodiment of the present disclosure;

FIG. 2B depicts a rear, perspective view of the digital signage shown in FIG. 2A;

FIG. 2C depicts a front, perspective view of digital signage according to an embodiment of the present disclosure;

FIG. 2D depicts a rear, perspective view of the digital signage shown in FIG. 2C;

FIG. 2E depicts a front of digital signage according to an embodiment of the present disclosure;

FIG. 2F depicts a rear, perspective view of the digital signage shown in FIG. 2F;

FIG. 3 depicts digital signage according to an embodiment of the present disclosure deployed in front of a home for sale; and

FIG. 4 depicts a digital signage system according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

It is an objective of the present disclosure to provide compact and portable digital signage that may be used in front of property for sale or businesses. In an embodiment, the digital signage may include an A-frame style. In an embodiment, the digital signage may include a dual vertical screens that may be suspended from a crosspiece of a traditional real estate for sale sign.

It is objective of the present disclosure to provide digital signage having dual screens such that it can be viewed from the front or the back. It is further an objective of the present disclosure to provide digital signage that is capable of displaying digital advertisements.

It is further an objective of the present disclosure to provide digital signage that includes the ability to make video or audio conferencing calls to pre-assigned contacts. In an embodiment, the present disclosure further provides digital signage with a printer that is able to print information on demand.

It is further an objective of the present disclosure to provide digital signage that is able to display a matrix or QR code such that consumers are able to scan the code with smart devices in order to receive additional information.

It is further an objective of the present disclosure to provide digital signage that is able to replace traditional signs used in the real estate industry.

It is further an objective of the present disclosure to provide digital signage suitable for outdoor use.

It is further an objective of the present disclosure to provide digital signage that incorporate their own cooling and heating systems to allow the signage to operate in extreme conditions.

It is further an objective of the present disclosure to provide digital signage with a digital camera and sound card to provide for bi-directional communication with customers and as a security safeguard.

It is further an objective of the present disclosure to provide digital signage with a ground anchor to prevent theft. It is further an objective of the present disclosure to provide digital signage with sensors to detect abnormal movement of the signage and to trigger a security system. In an embodiment, the security system may include a siren, video recording, audio recording and remote alerts.

It is further an objective of the present disclosure to provide digital signage with a connection to a network, such as a cellular network or Wi-Fi in order to engage in two-way communications with a computer server over the Internet. The network connection will further provide two-way communications between customers and sales agents.

It is further an objective of the present disclosure to provide a cloud based administrative system to control remote digital signage. In an embodiment, users may manage multiple digital signages through a website hosted on a web server. In an embodiment, users are able to select a marketing campaign for each of the digital signages using a wizard provided on the website. In an embodiment, the wizard may have pre-built templates to facilitate the creation of a marketing campaign. In an embodiment, users may further push information to the digital signages including, for example, information that may be printed on a printer.

It is further an objective of the present disclosure to allow a user to populate a template using information downloaded from a listing service operated by a third-party. In an embodiment, a user may download information from a real estate listing service.

It is further an objective of the present disclosure to provide digital signage that will add an entry in a database table stored on a computer readable storage medium with its unique identifier (Sign ID) and GPS coordinates each time it checks in. It will be appreciated that this will help prevent usage abuse of the sign according to the contracts as well as security tracking known positions.

It is further an objective of the present disclosure to provide digital signage for outdoor use that is powered by solar panels.

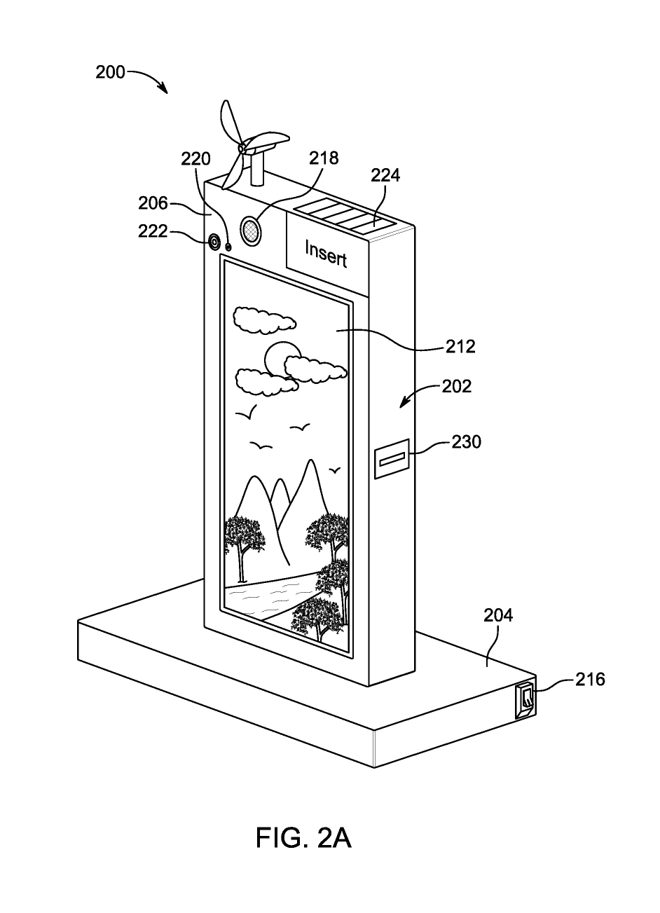

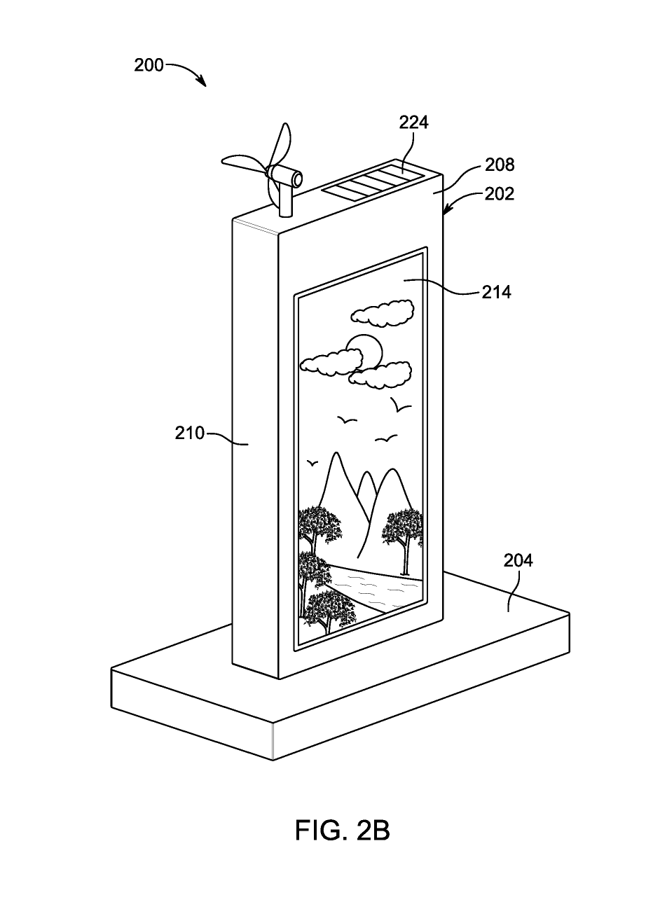

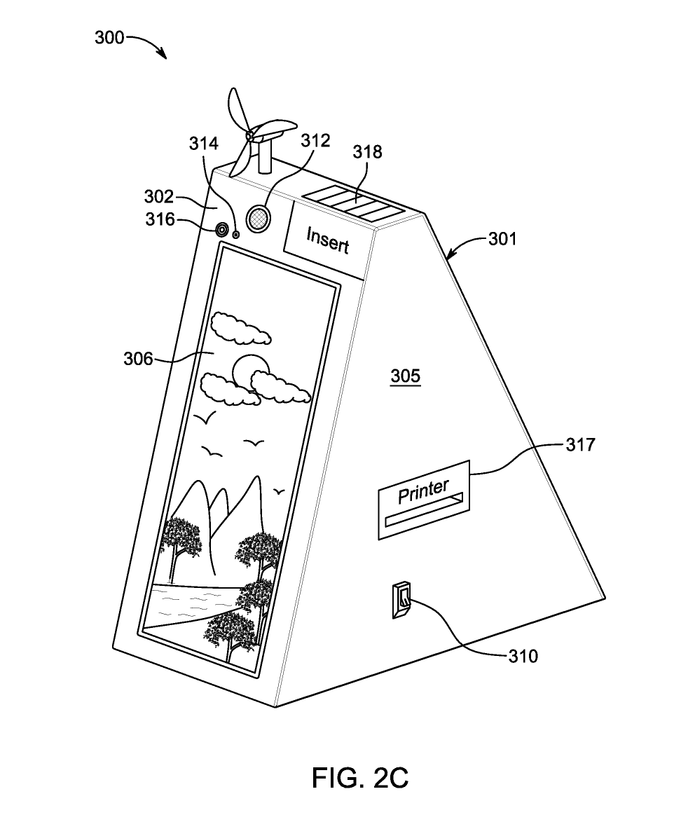

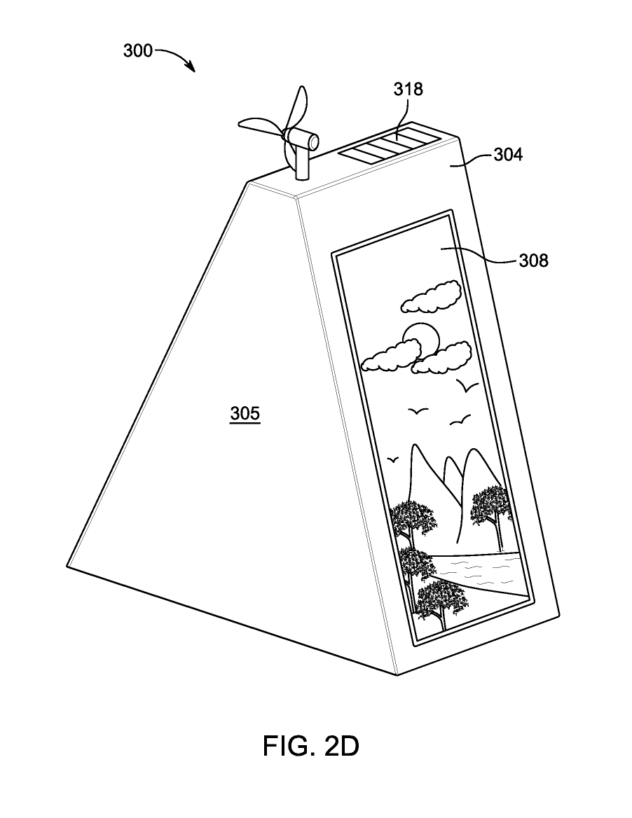

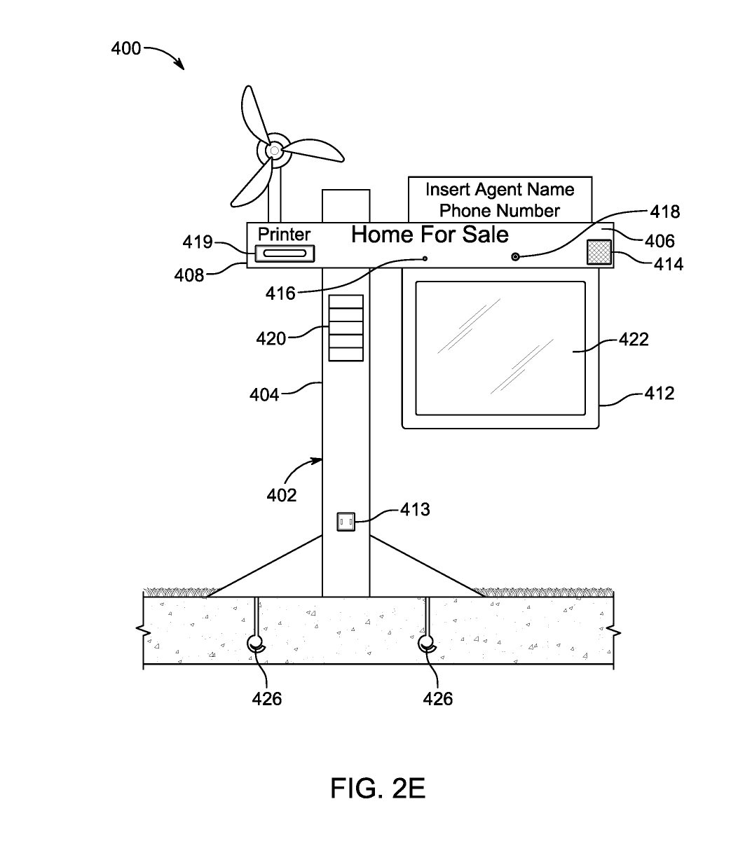

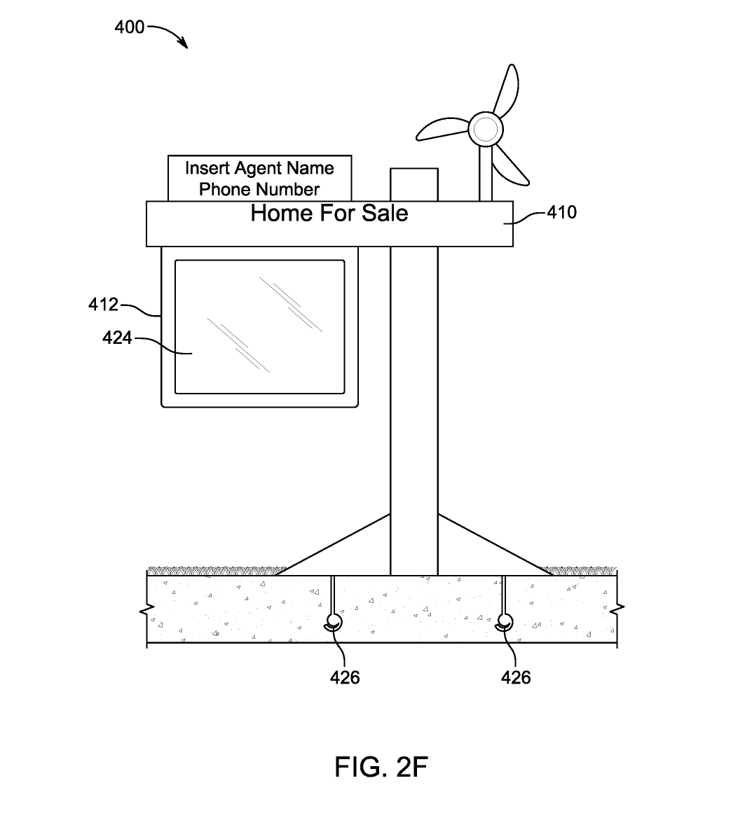

Referring now to FIGS. 2A and 2B, there is depicted a digital signage apparatus 200 according to an embodiment of the present disclosure. The apparatus 200 may include an enclosure 202 extending upwards from a base member 204. The enclosure 202 may include a front side 206 and a rear side 208. The front side 206 and the rear side 208 may be separated by a sidewall 210 that defines a separation between the frond side 206 and the rear side 208. In an embodiment, the enclosure 202 is box shaped. In an embodiment, the enclosure 202 is formed of a durable material such as plastic or metal. In an embodiment, the enclosure 202 is substantially weather-resistant, including watertight.

Disposed in the front side 206 of the enclosure 202 is a digital display 212 and disposed in the rear side 208 of the enclosure 202 is a digital display 214. In an embodiment, the distal displays 212 and 214 are oriented back-to-back. However, it will be appreciated that the digital displays 212 and 214 may be arranged in other orientations. In an embodiment, the digital displays 212 and 214 have sufficient resolution for displaying high quality images, including HD resolution. In an embodiment, the digital displays 212 and 214 are capable of display videos and images. In an embodiment, the digital displays 212 and 214 are weather resistant.

As mentioned, the enclosure 202 extends upwardly from a base member 204. In an embodiment, the enclosure 202 and the base member 204 are separate modules that are joined together using connectors. In an embodiment, the enclosure 202 and the base member 204 are formed as a unitary structure. The base member 204 may be weighted or secured to the ground using stakes in order to provide stability for the apparatus 200. The base member 204 may further include an outlet 216 for connecting the apparatus 200 to a power supply (not shown). The apparatus 200 may further include a speaker 218, a microphone 220, and a digital camera 222 that allow a user to perform two-way video conferencing as will be explained in more detail hereinafter. In an embodiment, the digital camera 222 is capable of capturing images both at day and at night. The apparatus 200 may further include a solar panel 224. The solar panel 224 may provide power to the displays 212 and 214 in the event that the connection to a public power grid is not available. The apparatus 200 may further include a battery that is charged by the solar panel 224.

It will be appreciated that the apparatus 200 is designed to be relatively portable such that it may be easily moved between locations. For example, the apparatus 200 may be utilized in front of stores or in association with real estate being offered for sale. Advantageously, the apparatus 200 may be utilized adjacent to roads or walkways because the dual displays allow the signage to be viewed by people traveling in either direction. In an embodiment, the apparatus 200 may include a built-in heating or cooling system to allow the displays 212 and 214 to operate in extreme weather conditions. The apparatus 200 may further comprise a printer 230.

In an embodiment, the base member 204 is secured to the ground using a ground anchor. The ground anchor may lock to the sign. The purpose of the ground anchor is to secure the apparatus in bad weather as well as to prevent theft of the apparatus 200. In an embodiment, the apparatus may include a security system that detects tampering with the apparatus 200. For example, the security system may include sensors to detect abnormal movement of the apparatus. The security system sensors may be one or more of an accelerometer, gyroscope, magnetometer, barometric altitude sensor. If the sensors prove an abnormal reading, the security system may sound a siren, transmit live video or audio signals, and/or send remote alerts electronically over a wireless network.

Referring now to FIGS. 2C and 2D, there is depicted a digital signage apparatus 300 according to an embodiment of the present disclosure. The apparatus 300 comprises an enclosure 301. As can be observed, the enclosure 301 of the apparatus 300 may have a generally A-frame shape. The enclosure 301 comprises front side 302 and a rear side 304. The front side 302 and the rear side 304 may be non-parallel to each other such that they define the legs of the generally A-frame shape of the enclosure 301. A pair of sidewalls 305 extends between the front side 302 and the rear side 304 of the enclosure 301. Disposed on the front side 302 of the enclosure 301 is a digital display 306 and disposed on the rear side 304 of the enclosure 301 is another digital display 308.

The apparatus 300 may further include an outlet 310 for connecting the apparatus 300 to a power supply (not shown). The apparatus 300 may further include a speaker 312, a microphone 314, and a digital camera 316 that allow a user to perform two-way video conferencing as will be explained in more detail hereinafter. In an embodiment, the digital camera 316 is capable of capturing images both at day and at night. In an embodiment, the enclosure 301 houses a printer 317. The apparatus 300 may further include a solar panel 318. The solar panel 318 may provide power to the displays 306 and 308 in the event that the connection to a public power grid is not available. The apparatus 300 may further include a battery within the enclosure that is charged by the solar panel 318.

It will be appreciated that the apparatus 300 is designed to be relatively portable such that it may be easily moved between locations. For example, the apparatus 300 may be utilized in front of stores or in association with real estate being offered for sale. Advantageously, the apparatus 300 may be utilized adjacent to roads or walkways because the dual displays allow the signage to be viewed by people traveling in either direction. In an embodiment, the apparatus 300 may include a built-in heating or cooling system to allow the displays 306 and 308 to operate in extreme weather conditions.

In an embodiment, the apparatus 300 is secured to the ground using a ground anchor. The ground anchor may lock to the sign. The purpose of the ground anchor is to secure the apparatus in bad weather as well as to prevent theft of the apparatus 300. In an embodiment, the apparatus may include a security system that detects tampering with the apparatus 300. For example, the security system may include sensors to detect abnormal movement of the apparatus. The security system sensors may be one or more of an accelerometer, gyroscope, magnetometer, barometric altitude sensor. If the sensors prove an abnormal reading, the security system may sound a siren, transmit live video or audio signals, and/or send remote alerts electronically over a wireless network.

Referring now to FIGS. 2E and 2F, there is depicted a digital signage apparatus 400 according to an embodiment of the present disclosure. The apparatus 400 comprises an enclosure 402 having a vertical post member 404 and a crosspiece member 406. The enclosure 402 may further comprise a suspended portion 412 that is disposed beneath the crosspiece member 406. The enclosure 402 includes a front side 408 and a rear side 410.

The apparatus 400 may further include an outlet 413 for connecting the apparatus 400 to a power supply (not shown). The apparatus 400 may further include a speaker 414, a microphone 416, and a digital camera 418 that allow a user to perform two-way video conferencing as will be explained in more detail hereinafter. In an embodiment, the digital camera 418 is capable of capturing images both at day and at night. The apparatus 400 may further include a solar panel 420. In an embodiment, the apparatus 400 includes a printer 419.

The front side 408 of the suspended portion 412 comprises a digital display 422. The rear side 410 of the suspended portion 412 comprises a digital display 424. In an embodiment, the solar panel 420 may provide power to the displays 422 and 424 in the event that the connection to a public power grid is not available. The apparatus 400 may further include a battery within the enclosure that is charged by the solar panel 420. Ground anchors 426 may be utilized to secure the apparatus 400 to the ground.

It will be appreciated that the apparatus 400 is designed to be relatively portable such that it may be easily moved between locations. For example, the apparatus 400 may be utilized in front of stores or in association with real estate being offered for sale. Advantageously, the apparatus 400 may be utilized adjacent to roads or walkways because the dual displays allow the signage to be viewed by people traveling in either direction. In an embodiment, the apparatus 400 may include a built-in heating or cooling system to allow the displays 422 and 424 to operate in extreme weather conditions.

In an embodiment, the apparatus may include a security system that detects tampering with the apparatus 400. For example, the security system may include sensors to detect abnormal movement of the apparatus. The security system sensors may be one or more of an accelerometer, gyroscope, magnetometer, barometric altitude sensor. If the sensors prove an abnormal reading, the security system may sound a siren, transmit live video or audio signals, and/or send remote alerts electronically over a wireless network.

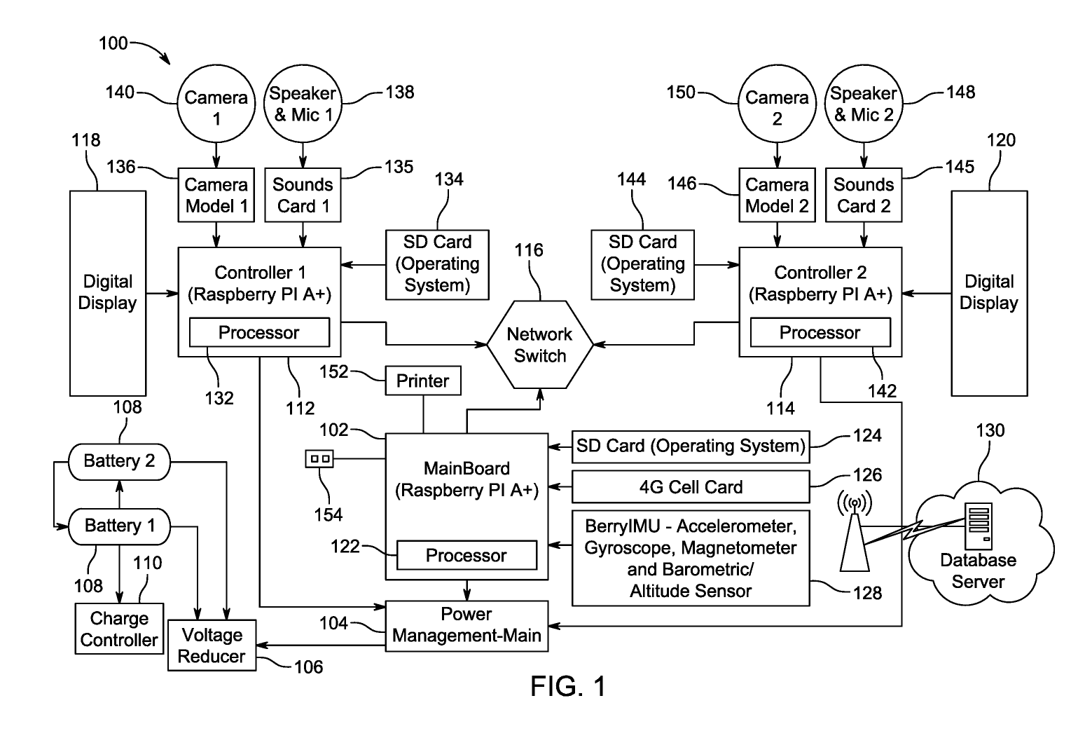

Referring now to FIG. 1, there is depicted a block diagram of the electronics of a system 100 suitable for the digital signage apparatuses 200, 300, and 400 disclosed herein. The system 100 has a main control module 102 that is connected to a power manager 104. The power manager 104 is connected to a voltage reducer 106 which may be connected to one or more batteries 108. The batteries 108 may be charged directly from AC power or from solar panels (not shown) using a charge controller 110. The main control module 102 is networked with a first display control module 112 and a second display control module 114 using a networked switch 116. The first display control module 112 and the second display control module 114 are also connected to the power manager 104. It will be appreciated that the first display control module 112 controls a first display 118 and that the second display control module 114 controls a second display 120.

The main control module 102 includes a processor 122 that is operable to control the content on the displays 118 and 120. The processor 122 is connected to a memory 124 that includes an operating system program as well as a display control program for running the system 100. It will be appreciated the processor 122 is capable of executing the instructions of the operating system program and the display control program. In an embodiment, the processor 122 is further connected to a cell card 126 such that the processor 122 is connectable to a cellular data and voice network to download and upload information from a database server 130 associated with a web server (not shown) that hosts a website. In addition, the cell card 126 may be permit two-way communication between two people. In an embodiment, the system 100 may include a Wi-Fi card that allows the processor 122 to communicate with the database server 130 over a Wi-Fi network. The processor 122 may be further connected to a user interface 154 that allows user to initiate commands and make requests, including printing and making requests as detailed herein.

In an embodiment, the processor 122 is further connected to one or more security sensors 128. These sensors 128 may include one or more of an accelerometer, gyroscope, magnetometer, and barometric/altitude sensor. In the event that one of the sensors 128 detects a reportable event, the sensors 128 send a signal to the processor 122. In response, the processor 122 activates a security routine that may include one or more of transmitting an alert, sounding an alarm, and/or activating a camera and a microphone. In an embodiment, the modules 102, 112 and 114 are single-board computers, such as a Raspberry Pi board manufactured by the Raspberry Pi Foundation. In an embodiment, the module 102 is connected to a printer 152.

The first display control module 112 includes a processor 132 that communicates through the network switch 116 with the processor 122 of the main control module 102. The processor 132 is connected to a memory 134 that includes an operating system program and a first display control program. The processor 132 is further connected to a sound card 135 and a digital camera controller 136. The sound card 135 is connected to a speaker and microphone 138. The digital camera controller 136 is connected to a digital camera 140. The first display control module 112 may be connected to the digital display 118 using an HDMI cable or any other type of suitable cable.

The second display control module 114 includes a processor 142 that communicates through the network switch 116 with the processor 122 of the main control module 102. The processor 142 is connected to a memory 144 that includes an operating system program and a first display control program. The processor 142 is further connected to a sound card 145 and a digital camera controller 146. The sound card 145 is connected to a speaker and microphone 148. The digital camera controller 146 is connected to a digital camera 150. The second display control module 114 may be connected to the digital display 120 using an HDMI cable or any other type of suitable cable.

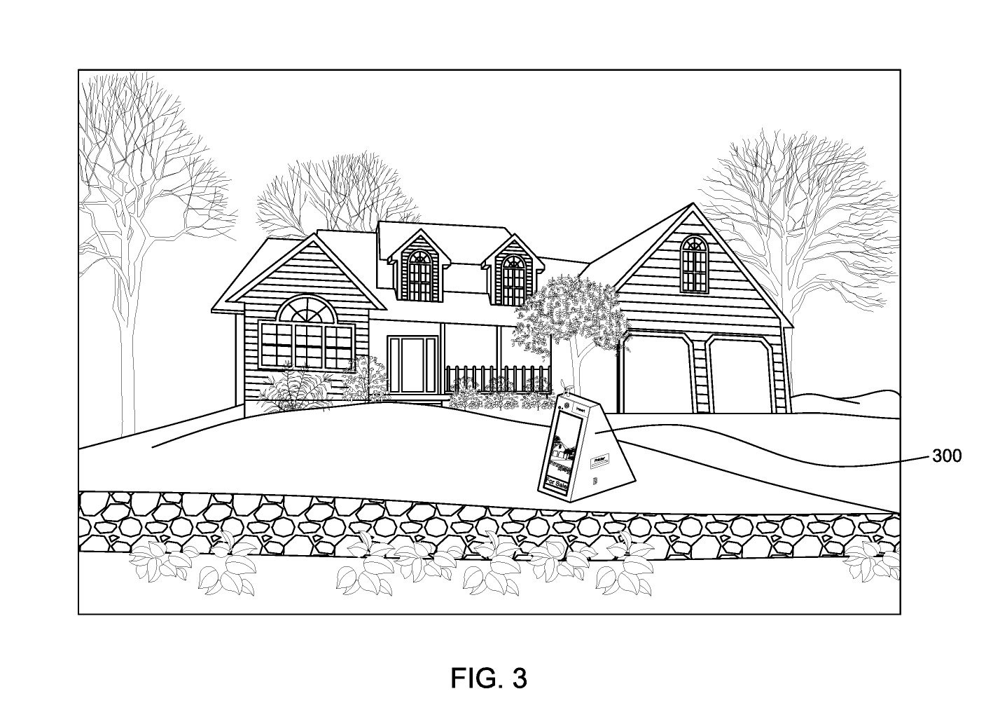

Referring now to FIG. 3, there is depicted the digital signage apparatus 300 placed in front of a home being offered for sale according to an embodiment of the present disclosure. It will be appreciated that the apparatuses 200 and 400 may be utilized in place of the apparatus 300.

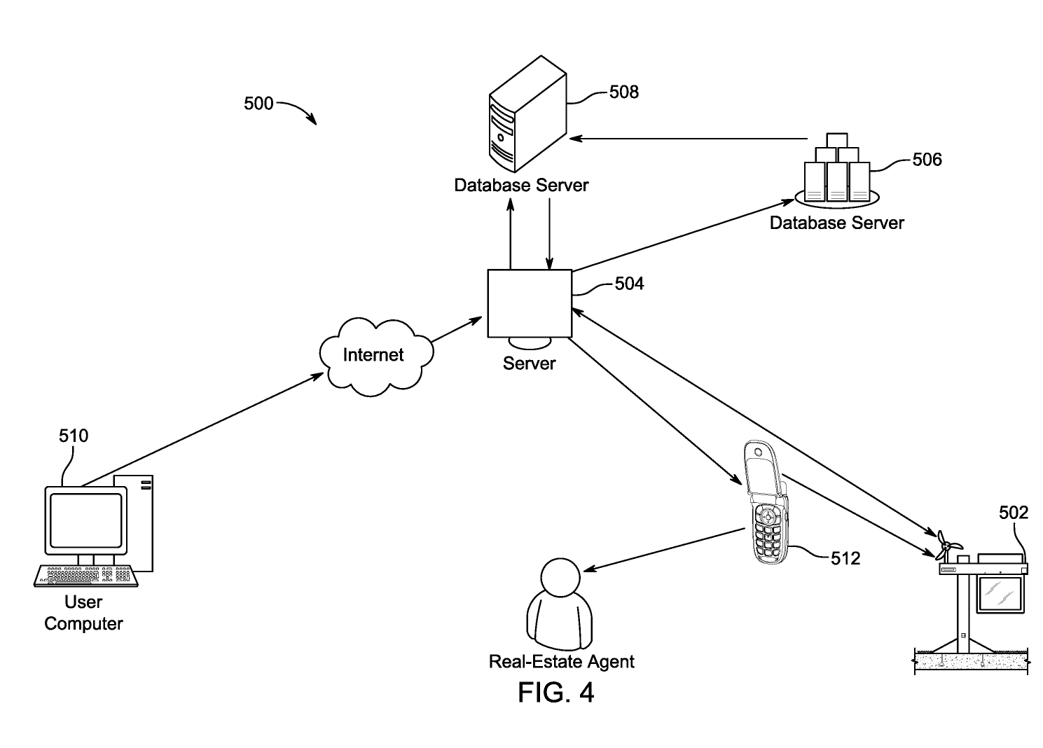

Referring now to FIG. 4, a system 500 for the operation of a digital signage apparatus 502 will now be described. (It will be appreciated that the apparatus 502 may take the form of apparatuses 200, 300 and 400.) The digital signage apparatus 502 may incorporate the system 100 as shown in FIG. 1. That is, the apparatus 502 may have dual digital displays mounted back-to-back in a weatherproof enclosure. The apparatus 502 may be placed in a public location, such as a storefront or in the front yard of a home being offered for sale. In an embodiment, the apparatus 502 is in communication with a centralized signage administrative server 504, such as a website or centralized server, over a network. It will be appreciated that the server 504 may be implemented on a single server, a cluster of servers, a server farm or data center, a cloud-hosted computing service, a cloud-hosted storage service, and so forth, although other computer architectures may additionally or alternatively be used. In an embodiment, the server 504 comprises at least one computer processor and a memory.

In an embodiment, the server 504 is connect to a third-party database server 506, such as a database that has information for a multiple listing service or MLS. In an embodiment, the server 504 is able to download data from the third-party database server 506. The server 504 may also be connected to local database server 508 where it can store information and data. The server 504 may further host a website that is accessible from a remote user computer 510 over a network, such as the Internet. In an embodiment, the apparatus 502 is able to communicate with a mobile phone 512 over a cellular network. For example, the apparatus 502 is able to dial and connect with a mobile phone of a real-estate agent such that a potential purchaser is able to video conference with the agent directly from the apparatus 502.

In an embodiment, the website hosted by the server 504 allows users to view and manage their sign's content. Due to security concerns for misuse of the sign, the web site will be encrypted with an SSL certificate. Two-factor authentication will be used to allow only authorized users. The access is powered by Role Based Access Control, meaning a company will have an administrator. The administrator can add users and assign signs to the correct users. The administrator will have visibility to all signs regardless of whom they are assigned to. One sign can have multiple users assigned to manage it.

Once logged in to the website hosted by the server 504, a user will have a list of signs currently assigned to their account. After clicking on the sign they want to manage, the current campaign will be displayed. With new signs, a new campaign wizard will guide the user through setup. Users can choose between prebuilt templates that have different formats or campaigns already setup in their account. Images can be uploaded and text can be updated. When changing a campaign, the user can overwrite or save a new campaign to preserve the original content. This way they can switch between campaigns if they wish. Each campaign will be a package, including webpages and images.

The server 504 will push settings to the apparatus 502, including information that will get printed on a thermal printer installed on the apparatus. The printer will print an info sheet with a QR code, property details, images and contact info for the realtor. The website contains a section for each sign for a person that can be contacted from the sign through video or audio conferencing. Additionally, a schedule for when the contact person would like to receive calls.

A user managing the apparatus 502 can type in an MLS number into the website which will allow the server 504 to connect to the MLS server through API calls. Property details, images and realtor information will be imported automatically into the database server 508. The user can choose which data they want to include and push to the apparatus 502.

The apparatus 502 uses the mainboard's 4G connection to check for updates every 60 minutes on the server 504. After creating the connection to the Internet using the cell card, a SSL VPN connection will be established to the server 504. Updates will be compressed using a compression utility so that it saves bandwidth during the transfer. The apparatus 502 will check for updates and if there are changes it will download a new package. The apparatus 502 will add an entry in a database table on the database server 508 with its unique Identifier (Sign ID) and GPS coordinates each time it checks in. This will help prevent usage abuse of the sign according to the contracts as well as security tracking known positions. Once it is downloaded, the apparatus 502 will unpack the compressed content to the campaign's folder stored in memory. The folder structure provides a way that will have paid advertising integrated into the existing campaigns. Once the files are extracted, the apparatus restarts the web service to load the new data.

In an embodiment, the apparatus comes with a preloaded active DEMO campaign. A file named “CurrentlyActive.txt” will be located in the campaign folder and will contain the currently active content that will display on the sign. Additionally, the campaign folder will include more folders for each campaign that can be used on the sign including the current house info, other houses listed by the owner or Ad's. For technical support, SSH remote control is established through a secure connection over the 4G interface.

It will be appreciated that a user of the user computer 510 is able to manage the content displayed on the apparatus 502 through a website hosted by the server 504. The user may manage more than one sign through the website. Although not shown, multiple users may each manage one or more signs through the website. In this regard, each user may be assigned a unique login and password to access the managing features provided by the website hosted by the server 504.

In an embodiment, the server 504 may download data to a local database server 508 from a third-party database server 506. For example, the server 504 may cause data regarding a home listing to be downloaded from the remote database server 506 to the local database server 508 in response to information input by a user at the user computer 510. The data on the server 504 may be pushed or pulled to the apparatus 502. For example, this data may include images, video, and other information about a home being offered for sale. A user of the user computer 510 may further define different promotional campaigns through the website hosted by the server 504. Each promotional campaign defines the content to be displayed by the apparatus 502 to potential customers. Each promotional campaign may further define the sequence of the content to be displayed by the apparatus 502.

A potential customer adjacent the apparatus 502 is able to view the campaigns on the displays. In addition, a potential customer is able to initiate a video conferencing session with an assigned agent using the digital camera, speaker and microphone of the apparatus 502. The agent is able to video conference using a mobile phone or computer. The agents contact information may be pre-programmed into the apparatus 502. In addition, a potential customer is able to print information from the printer of the apparatus 502.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A digital signage apparatus, comprising:
an enclosure;
a pair of digital displays mounted in the enclosure;
a network communication module mounted in the enclosure, said network communication module operable to communicate with a remote computer server over a network;
a main control module comprising a processor and a computer memory, wherein the computer memory comprises computer readable instructions that, when executed by the processor, cause the main control module to cause the network communication module to automatically establish communications with a remote computer server over the network and download digital content for display on the pair of digital displays.

2. The apparatus of claim 1, wherein the digital displays are mounted back-to-back.

3. The apparatus of claim 1, wherein the enclosure is an A-shape.

4. The apparatus of claim 1, wherein the enclosure comprises a vertical post and a crosspiece member, wherein the pair of digital displays are suspended beneath the crosspiece member.

5. The apparatus of claim 1, further comprising a microphone, digital camera and speaker.

6. The apparatus of claim 1, further comprising a battery and a solar panel, wherein the solar panel is operable to charge the battery.

7. The apparatus of claim 1, further comprising at least one sensor for detecting a pre-defined security incident.

8. The apparatus of claim 1, wherein the enclosure is weatherproof.

9. The apparatus of claim 1, further comprising a printer mounted in the enclosure.

10. The apparatus of claim 1, wherein the digital displays are weatherproof.

11. The apparatus of claim 1, further comprising a first display control module comprising a processor and a memory and a second display control module comprising a processor and a memory, wherein the first display control module controls a display of content on one of the digital displays and the second display control module controls a display of content on the other one of the digital displays.

12. The apparatus of claim 11, further comprising a network switch within the enclosure, wherein the main control module communicates with the first display control module and the second display control module through the network switch.

13. The apparatus of claim 1, wherein the network communications module is a cellular network card.

14. The apparatus of claim 1, wherein the computer memory further comprises computer readable instructions that, when executed by the processor, cause the main control module to cause the network communication module to automatically establish communications with a mobile phone.

15. The apparatus of claim 1, wherein the enclosure comprises a vertical portion and a base member, wherein the vertical portion extends upwardly from the base member, wherein the pair of digital displays are mounted back-to-back in the enclosure.

16. The apparatus of claim 1, further comprising one or more anchors for securing the enclosure to the ground.

17. A system for controlling a plurality of digital signage apparatuses from a remote location, said system comprising:
a centralized computer server hosting a website, said centralized computer server providing one or more webpages of the website to a remote user computer over a network in response to a request;
said webpages providing a user interface that allows a user to define a promotional campaign for selected ones of the plurality of digital signage apparatuses;
said webpages providing one or more templates to assist the user in defining the promotional campaign; and
wherein said centralized computer server provides the promotional campaign as defined by the user to the selected ones of the plurality of digital signage apparatuses.

18. The system of claim 17, wherein the centralized computer server is further operable to download listing information from a third-party website; wherein the centralized computer server provides the listing information to at least one of the digital signage apparatuses.

19. The system of claim 17, wherein the webpages provide an interface that allow a user to upload multimedia content to the centralized computer server for inclusion in a promotional campaign.

20. A method of promoting an item for sale, said method comprising:
placing a digital signage apparatus adjacent the item being offered for sale, said digital signage apparatus comprising:
an enclosure,
a pair of digital displays mounted in the enclosure,
a network communication module mounted in the enclosure,
said network communication module operable to communicate with a remote computer server over a network,
a main control module comprising a processor and a computer memory, wherein the computer memory comprises computer readable instructions that, when executed by the processor, cause the main control module to cause the network communication module to automatically establish communications with a remote computer server over the network and download digital content for display on the pair of digital displays,
wherein the digital displays are mounted back-to-back,
a microphone, digital camera and speaker,
wherein the enclosure is weatherproof,
a printer mounted in the enclosure,
wherein the digital displays are weatherproof,
a first display control module comprising a processor and a memory and a second display control module comprising a processor and a memory,
wherein the first display control module controls a display of content on one of the digital displays and the second display control module controls a display of content on the other one of the digital displays
a network switch within the enclosure,
wherein the main control module communicates with the first display control module and the second display control module through the network switch,
wherein the network communications module is a cellular network card,
wherein the computer memory further comprises computer readable instructions that, when executed by the processor, cause the main control module to cause the network communication module to automatically establish communications with a mobile phone.
